(19) United States
(12) Patent Application Publication
(10) Pub. No.: US 2014/0220391 A1
(43) Pub. Date: Aug. 7, 2014

(54) POWER SOURCE APPARATUS, AND VEHICLE AND POWER STORAGE DEVICE EQUIPPED WITH THAT POWER SOURCE APPARATUS

(71) Applicants: Kazuhiro Fujii, Hyogo (JP); Takashi Seto, Hyogo (JP)

(72) Inventors: Kazuhiro Fujii, Hyogo (JP); Takashi Seto, Hyogo (JP)

(73) Assignee: Sanyo Electric Co., Ltd.,, Osaka (JP)

(21) Appl. No.: 14/240,899

(22) PCT Filed: Aug. 22, 2012
(86) PCT No.: PCT/JP2012/071241

§ 371 Date: Feb. 25, 2014

(30) Foreign Application Priority Data
Aug. 26, 2011 (JP) 2011-185346

(51) Int. Cl. H01M 2/10; H01M 10/625; H01M 10/6554; B60L 11/18; H01M 10/42

(52) U.S. Cl. CPC H01M 2/1077; B60L 11/1877; H01M 10/4257; H01M 10/5053; H01M 10/5016; H01M 2/1083; H01M 2/1094; H01M 2220/20
USPC 429/7

(57) ABSTRACT

A power source apparatus provided with a battery stack having a plurality of rectangular shaped rechargeable battery cells stacked together, a circuit board carrying electronic circuitry electrically connected with the rechargeable battery cells, a circuit board holder disposed on the upper surface of the battery stack that establishes circuit board storage space to hold the circuit board, and a conducting shield plate installed on top of the circuit board holder that closes-off at least the upper surface of the circuit board storage space holding the circuit board inside.

### BACKGROUND OF THE INVENTION

1. Field of the Invention

The present invention relates to a power source apparatus primarily used to power a motor that drives a vehicle such as a hybrid vehicle (hybrid car, hybrid electric vehicle, HEV) or electric vehicle (EV, electric automobile) or used as a high current power source apparatus for applications such as power storage in the home or in industry, and to a vehicle and power storage device equipped with that power source apparatus.

2. Description of the Related Art

There is demand for power source apparatus with high output, such as those for automotive applications. These types of power source apparatus have many battery cells connected in series to increase the output voltage and deliver high power. To drive a high output motor, circuitry connected to the motor must be high voltage circuitry. The high voltage circuitry is switched ON and OFF via high voltage relays (contactors).

A plurality of individual battery cells are stacked together in block configuration, and a circuit board carrying low voltage circuitry is provided for each battery stack. The low voltage circuitry performs battery cell voltage and temperature detection to protect the battery cells that make up the battery stack, or can include equalizing circuitry to equalize remaining battery capacity among the cells.

However, this arrangement is accompanied by concern that the low voltage circuitry could be affected each time the relay contactors connected to the high voltage circuitry switch ON or OFF. Consequently, to avoid malfunction due to externally generated (electromagnetic) noise, structures that shut-out external noise, such as metal enclosures that cover the circuit boards, are included as a design consideration.

In contrast, a compact power source apparatus is desirable. For example, in the case of a power source such as a battery array for automotive applications, sufficient space may not be available for installation of a large power source apparatus. Consequently, to reduce the size of the power source apparatus without decreasing the number of battery cells, a power source apparatus with low the voltage circuitry disposed on its upper surface to shorten the connecting wires has been disclosed (refer to Japanese Laid-Open Patent Publication 2006-012805).

For additional reference see:
Japanese Laid-Open Patent Publication 2009-134901;
Japanese Laid-Open Patent Publication 2009-134936;
Japanese Laid-Open Patent Publication 2010-15788;
Japanese Laid-Open Patent Publication SHO-34-16929 (1959);
Japanese Laid-Open Patent Publication 2005-149837; and
Japanese Laid-Open Patent Publication 2002-100407.

In the power source apparatus of Japanese Patent Publication 2006-012805, a structure that covers the circuit board with a metal case is adopted as a strategy to reduce the effect of noise on the circuit board disposed on the upper surface of the battery stack. With this structure, in addition to the printed circuit board, the metal case covering the printed circuit board is also disposed on the upper surface of this power source apparatus. Consequently, it has the problem that the power source apparatus becomes larger.

The present invention was developed to resolve these types of problems. Thus, it is a primary object of the present invention to provide a power source apparatus, and vehicle and power storage device equipped with that power source apparatus that can suppress noise for high-reliability operation while restraining the structural size of the power source apparatus.

### SUMMARY OF THE INVENTION

To achieve the object described above, the power source apparatus for the first aspect of the present invention can be provided with a battery stack having a plurality of rectangular shaped rechargeable battery cells stacked together, a circuit board carrying electronic circuitry electrically connected with the rechargeable battery cells, a circuit board holder disposed on the upper surface of the battery stack that establishes storage space to hold the circuit board, and a conducting shield plate installed on top of the circuit board holder that closes-off at least the upper surface of the circuit board storage space holding the circuit board inside. This allows the shield plate covering the upper surface of the circuit board to shut-out external noise entering from above the circuit board, and disposition of the battery stack below the circuit board utilizes the battery stack as an obstruction that dissipates external noise introduced from below. This configuration allows the circuit board to be shielded from electromagnetic interference to insure stable operation without completely covering (all sides) of the circuit board with the shield plate to achieve a compact power source apparatus.

The power source apparatus for the second aspect of the present invention can be further provided with a pair of metal endplates disposed at the ends of the battery stack, and metal binding pieces that cover the sides of the battery stack and bind the stack of battery cells together by holding the pair of endplates in place. This allows the endplates and binding pieces to serve as shielding material on the under surface of the circuit board, and allows reduction in the extent of area requiring shielding by the shield plate. Specifically, since the under surface of the circuit board can be shielded from external noise (electromagnetic interference) by structures such as the endplates and binding pieces, there is no requirement for additional shield plating below the circuit board, and this simplifies the anti-noise strategy.

In the power source apparatus for the third aspect of the present invention, the shield plate can cover only the upper surface of the battery stack. This limits the region where the shield plate is disposed for protection from external noise to the upper surface of the battery stack. By covering other surfaces with metal materials that serve as shielding, additional parts cost for anti-noise design can be reduced.

In the power source apparatus for the fourth aspect of the present invention, the shield plate can be made of aluminum. This allows the shield plate to be made inexpensively.

In the power source apparatus for the fifth aspect of the present invention, the circuit board can be covered with resin having good heat transfer properties, and the shield plate can be thermally coupled with the resin. This not only gives the circuit board moisture protection, but is also designed to physically protect the circuit board.

In the power source apparatus for the sixth aspect of the present invention, the circuit board can implement low voltage circuitry. Low voltage circuitry, which is easily affected by noise, can be protected by the shield plate and other structural elements of the power source apparatus.

The power source apparatus for the seventh aspect of the present invention can be further provided with a circuit board holder bottom-cover to support the bottom surface of the circuit board holder, and the circuit board holder bottom-cover can be attached to the upper surface of the battery stack in a water-tight manner. This utilizes the circuit board holder bottom-cover to hermetically seal the upper surface of the battery stack, and can inexpensively implement a water-tight structure using existing circuit board holder parts without requiring additional components for moisture protection.

The power source apparatus for the eighth aspect of the present invention can be further provided with a cooling plate that passes coolant (cooling medium) through its interior and is thermally coupled with one surface of the battery stack to transfer heat from the battery stack, and a thermally conducting sheet disposed between the cooling plate and the bottom surfaces of the battery cells to connect the cooling plate and battery cells in a thermally coupled manner. Since the bottom surface of the battery stack is covered with the metal cooling plate, external random noise emanating from below the circuit board can be shut-out even more reliably.

The vehicle for the ninth aspect of the present invention is equipped with the power source apparatus described above.

The power storage device for the ninth aspect of the present invention is equipped with the power source apparatus described above.

### BRIEF DESCRIPTION OF THE DRAWINGS

FIG. 1 is an exploded perspective view of a power source apparatus for the first embodiment of the present invention;

FIG. 2 is a perspective view showing a battery array in FIG. 1;

FIG. 3 is an exploded a perspective view showing the cooling plate removed from the battery stack in FIG. 2;

FIG. 4 is an exploded perspective view from below the battery stack shown in FIG. 2;

FIG. 5 is an exploded perspective view showing the battery array in FIG. 2;

FIG. 6 is an exploded perspective view of the battery stack in FIG. 5;

FIG. 7 is a vertical cross-section taken along line VII-VII on the battery stack in FIG. 2;

FIG. 8 is a vertical cross-section taken along line VIII-VIII on the battery stack in FIG. 2;

FIG. 9 is a schematic plan view showing the cooling plate configuration;

FIG. 10 is a block diagram showing an example of a power source apparatus installed on-board a hybrid vehicle driven by an engine and a motor;

FIG. 11 is a block diagram showing an example of a power source apparatus installed on-board an electric vehicle driven by a motor only; and

FIG. 12 is a block diagram showing an example of a power source apparatus used in a power storage application.

### DETAILED DESCRIPTION OF THE EMBODIMENT(S)

The following describes embodiments of the present invention based on the figures. However, the following embodiments are merely specific examples of a power source apparatus, and vehicle and power storage device equipped with that power source apparatus representative of the technology associated with the present invention, and the power source apparatus, and vehicle and power storage device equipped with that power source apparatus of the present invention is not limited to the embodiments described below. Further, components cited in the claims are in no way limited to the components indicated in the embodiments. In the absence of specific annotation, structural component features described in the embodiment such as dimensions, raw material, shape, and relative position are simply for the purpose of explicative example and are in no way intended to limit the scope of the invention. Properties such as the size and spatial relation of components shown in the figures may be exaggerated for the purpose of clear explanation. In the descriptions following, components with the same name and label indicate components that are the same or have the same properties and their detailed description is appropriately abbreviated. Further, a single component can serve multiple functions and a plurality of structural elements of the invention can be implemented with the same component. In contrast, the functions of a single component can be divided among a plurality of components. In addition, explanations used to describe part of one embodiment may be used in other embodiments.

### First Embodiment

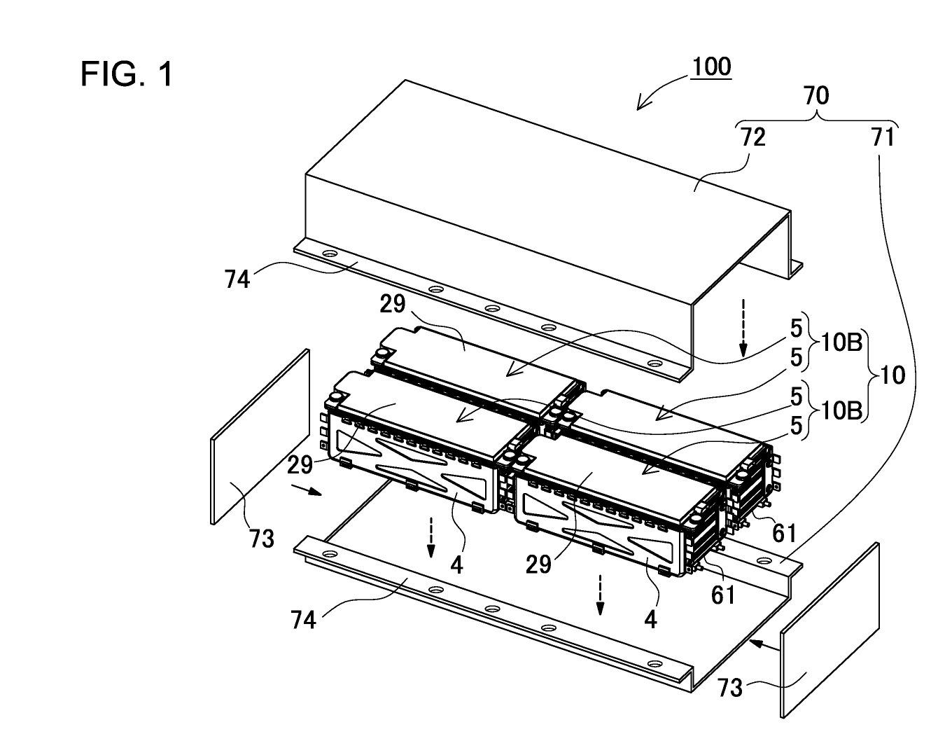

As the power source apparatus 100 for the first embodiment of the present invention, FIGS. 1-8 illustrate an example of an automotive power source apparatus suitable for installation on-board a vehicle. This power source apparatus 100 is primarily carried on-board an electric-powered vehicle such as a hybrid vehicle or electric vehicle, and is used to drive the vehicle by supplying power to the driving motor. However, the power source apparatus of the present invention can also be used in electric-powered vehicles other than hybrid or electric vehicles, and can also be used in applications that require high power output other than electric-powered vehicles.

### (Power Source Apparatus 100)

As shown in the exploded perspective view of FIG. 1, the power source apparatus 100 has a box-shaped external appearance with a rectangular upper surface. The power source apparatus 100 has a battery assembly 10 (or a plurality of battery assemblies 10) held inside a box-shaped outer case 70 that is divided into two pieces. The outer case 70 is provided with an upper case 72, a lower case 71, and end-plane pieces 73 fastened at both ends of the upper and lower cases 72, 71. The outsides of the upper and lower cases 72, 71 have flanges 74 where the upper and lower cases 72, 71 are fastened together with nuts and bolts. The flanges 74 are disposed on the sides of the outer case 70. In the example shown in FIG. 1, two lengthwise rows of battery stacks 5 with two battery stacks 5 in each row (for a total of four battery stacks 5) are held in the lower case 71. Each battery stack 5 is attached in a fixed position inside the outer case 70. End-plane pieces 73 are fastened to both ends of the upper and lower cases 72, 71 to close-off the ends of the outer case 70.

### (Battery Assembly 10)

In the example shown in FIG. 1, the battery assembly 10 is made up of four battery stacks 5. Specifically, two battery stacks 5 are linked together in the rectangular battery cell stacking direction to form a single linked battery stack unit 10B, and two linked battery stack units 10B are adjacently disposed in a parallel manner to form the battery assembly 10.

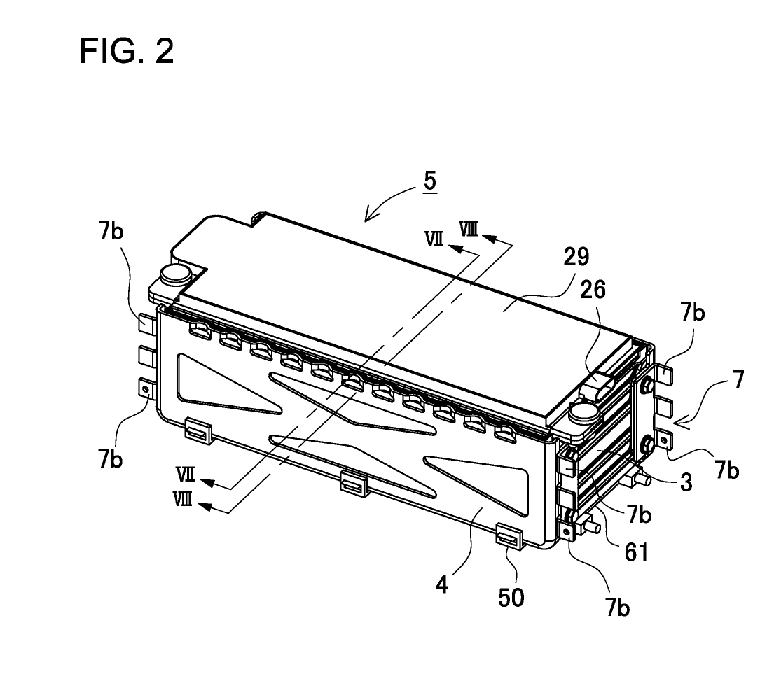

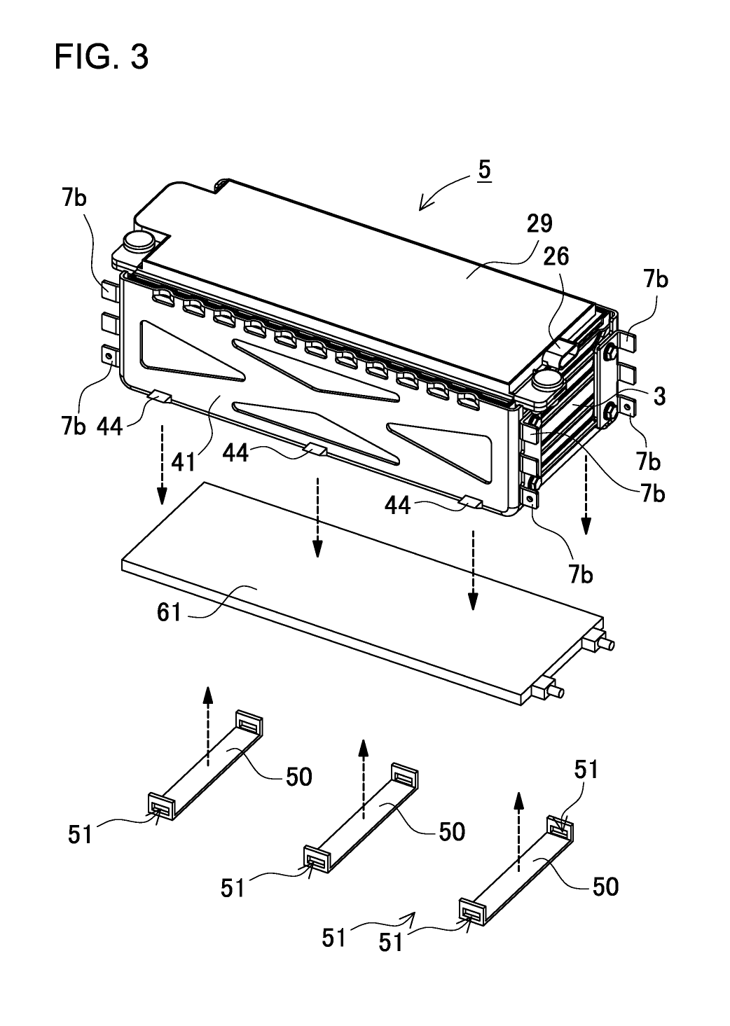

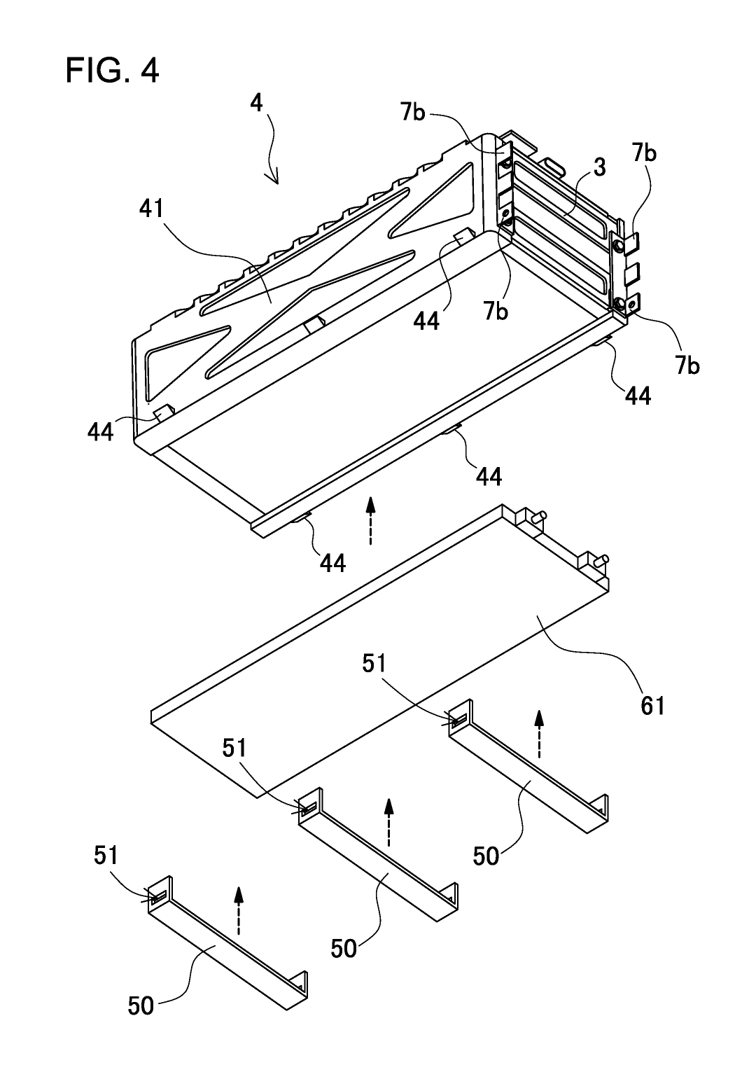

A perspective view of one of the battery stacks 5 that make up the battery assembly 10 is shown in FIG. 2. The battery stack 5 is mounted on top of a cooling plate 61 designed to cool the battery stack 5. As shown in FIGS. 2-4, the battery stack 5 is provided with connecting structures for attachment on top of the cooling plate 61 (described in detail later). FIG. 3 is an exploded perspective view of the battery stack 5 with the cooling plate 61 removed as viewed obliquely from above, and FIG. 4 is the same battery stack 5 and cooling plate 61 as viewed obliquely from below.

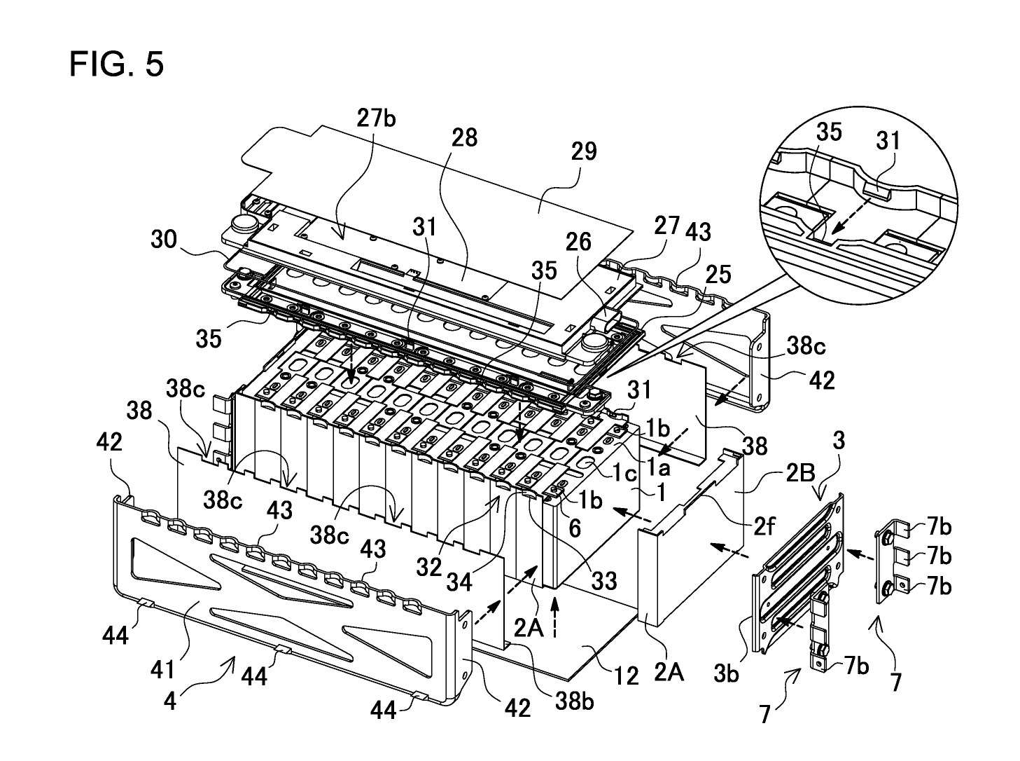

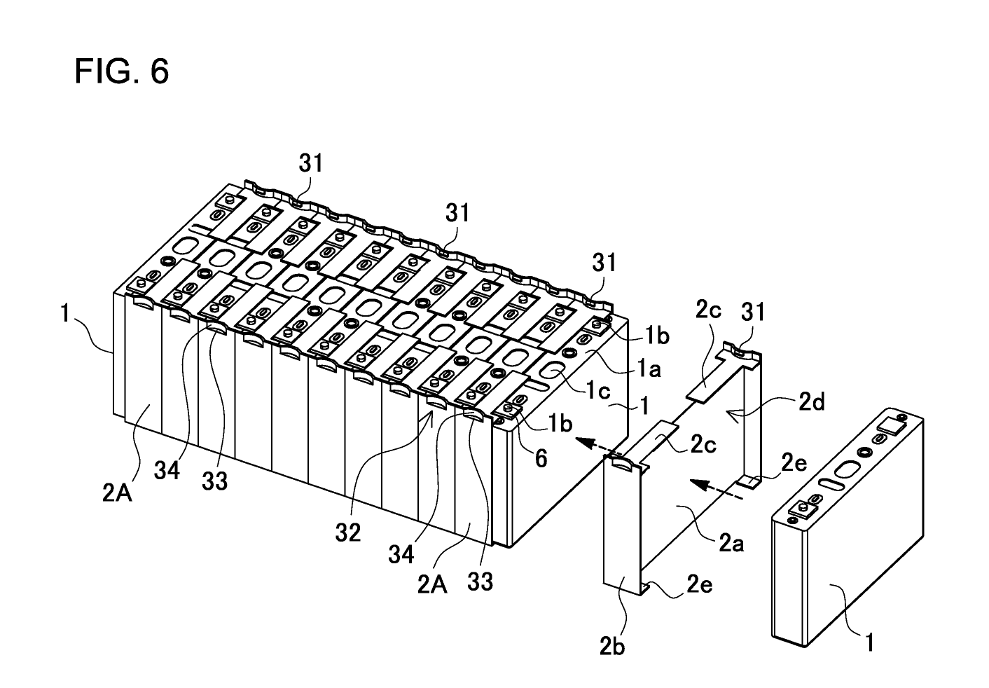

FIG. 5 is an exploded perspective view showing the battery stack 5 and disassembled parts such as the binding pieces 4, and FIG. 6 is an exploded oblique view showing the stacking configuration of the rechargeable battery cells 1 and separators 2 that make up the battery stack 5. As shown in FIGS. 5 and 6, each battery stack 5 is provided with a plurality of rechargeable battery cells 1, separators 2 intervening between the stacked surfaces of the rechargeable battery cells 1 to insulate adjacent cells, a pair of endplates 3 disposed at the ends of the alternating stack of rechargeable battery cells 1 and separators 2 (battery stack 5), a plurality of metal binding pieces 4 that bind together the endplates 3 disposed at the two ends of the battery stack 5, and moisture protection sheets 38 that cover the rechargeable battery cells 1 in a water-tight manner disposed between the binding pieces 4 and the sides of the battery stack 5.

### (Battery Stack 5)

As shown in FIG. 6, the battery stack 5 has a plurality of rechargeable battery cells 1 stacked with intervening insulating separators 2. Further, as shown in FIG. 5, the battery stack 5 has a pair of endplates 3 disposed at the ends of the stack, and binding pieces 4 connecting the pair of endplates 3. In this manner, insulating separators 2 intervene between the stacking surfaces of adjacent rechargeable battery cells 1, and a plurality of battery cells 1 and separators 2 are alternately stacked to form the battery stack 5.

### (Rechargeable Battery Cell 1)

As shown in FIG. 6, the rechargeable battery cell 1 external case, which determines the outline of the battery cell, has a rectangular shape with a thickness that is narrower than the width. A sealing plate 1a that closes-off the top of the external case is provided with positive and negative electrode terminals 1b as well as a safety valve 1c disposed between the electrode terminals 1b. The safety valve 1c is configured to open and discharge the gas inside when pressure in the external case rises above a given value. By opening the safety valve 1c, pressure rise inside the external case can be halted. A unit cell that makes up a rechargeable battery cell 1 is a battery (cell) that can be charged such as a lithium ion battery, nickel hydride battery, or nickel cadmium battery. In particular, when a lithium ion battery is used as the rechargeable battery cell 1, it is characterized by high charging capacity relative to overall battery cell volume and mass. The battery cell used in the present invention is not limited to a rectangular battery cell and a circular cylindrical battery cell or a laminate-type battery cell with a rectangular or other shape can also be used.

Adjacent positive and negative electrode terminals 1b of the rechargeable battery cells 1 stacked to form the battery stack 5 are connected together via bus-bars 6 for series connection. A battery assembly 10 with adjacent rechargeable battery cells 1 connected in series can produce high output voltage and power. However, the battery assembly can also be connected with adjacent battery cells in parallel, or in a combination of series-parallel or parallel-series connections. Each rechargeable battery cell 1 is made with a metal external case. Insulating separators 2 are sandwiched between adjacent rechargeable battery cells 1 to prevent short circuit between the metal external cases. Note, rechargeable battery cell external cases can also be made of insulating material such as plastic. In that case, since there is no need to insulate the external cases in the stack of rechargeable battery cells, the separators can be made of metal or the cells can be stacked without separators.

### (Separator 2)

Separators 2 are spacers stacked with the rechargeable battery cells 1 to electrically and thermally insulate adjacent battery cells. Separators 2 are made of insulating material such as plastic, and are disposed between adjacent rechargeable battery cells 1 to insulate the battery cells. As shown in the exploded perspective views of FIGS. 5 and 6, each separator 2 has battery cell retaining sections 2d established on both surfaces where rechargeable battery cells 1 can be held. For this reason, a separator 2 is provided with a flat separator plate 2a essentially the same size as the primary (stacking) surfaces of the rechargeable battery cells 1, side-walls 2b that cover side surfaces of the rechargeable battery cells 1, and upper surface plates 2c that partially cover the upper surfaces (sealing plates) of the rechargeable battery cells 1. Two separators 2 that sandwich a rechargeable battery cell 1 in between enclose the side surfaces of the battery cell. Accordingly, the side-walls 2b are approximately the same size as the side surfaces of a rechargeable battery cell 1. By attachment of the flat separator plate 2a approximately at the center of the side-walls 2b, a rechargeable battery cell 1 disposed in a retaining section 2d has approximately half of each side surface covered by half of each side-wall 2b. The tops of the battery cell retaining sections 2d partially cover rechargeable battery 1 sealing plates 1a with upper surface plates 2c. The upper surface plates 2c cover the boundary between adjacent rechargeable battery cells 1 while exposing the electrode terminals 1b and safety valves 1c. In contrast, the bottoms of the battery cell retaining sections 2d are open to expose the bottom surfaces of the rechargeable battery cells 1. The open bottom region is for the purpose of heat exchange between the bottom surfaces of the rechargeable battery cells 1 and the cooling plate 61 (described later).

(Bottom Projections 2e)

As shown in the exploded oblique view of FIG. 6, bottom projections 2e are provided extending along the bottom plane from the lower ends of the side-walls 2b to cover the corners and allow rechargeable battery cell 1 alignment in the separator 2. In addition, the flat separator plate 2a, which has its bottom edge disposed between bottom projections 2e at both ends, is terminated slightly above the bottom of the rechargeable battery cells 1. This structure can avoid the case where separator 2 manufacturing tolerances result in separator 2 bottom edge protrusion below the bottom surfaces of the rechargeable battery cells 1 preventing cooling plate contact with the bottom surfaces of the battery cells.

In contrast, as shown in the exploded oblique views of FIGS. 5 and 6, the side-walls 2b of the separators 2 are made slightly taller than the rechargeable battery cells 1. Further, the upper surface plates 2c are attached at positions approximately equal to the height of the rechargeable battery cells 1. When rechargeable battery cells 1 are loaded in separator 2 battery cell retaining sections 2d, the side-walls 2b are configured to project slightly above the upper surface of the battery stack 5 on both sides. These projecting sections of the side-walls 2b align and retain the circuit board holder bottom-cover 25 on the upper surface of the battery stack 5. Latching hooks 31 to attach the circuit board holder bottom-cover 25 (described in detail later) are established on the insides of the side-walls 2b, which are the side-wall surfaces facing the upper surface plates 2c. In addition, indents 32 are formed on the outsides of the projecting sections of the side-walls 2b to accept upper retaining projections 43 on the binding pieces 4. Each indent 32 is formed in a ledge shape having a horizontal ledge surface 33 with a recessed back wall section 34.

A plurality of separators 2A having the same shape are used. However, as shown in the exploded oblique view of FIG. 5, separators disposed at the ends of the battery stack 5 between the last rechargeable battery cell 1 and the endplate 3 are configured differently. This end separator 2B insulates the last rechargeable battery cell 1 from the metal endplate 3. Each end separator 2B has a battery cell retaining section 2d established on one surface only, and the opposite surface is made planar for contact with the endplate 3 with no projecting side-walls, upper surface plates, or bottom projections. In addition, the top of the planar surface of each end separator 2B has a projecting piece 2f established to retain the circuit board holder bottom-cover 25.

Note that the battery stack does not necessarily have to have separators intervening between the rechargeable battery cells. For example, rechargeable battery cell external cases can be made of insulating material, or the outer surfaces of the external cases can be covered with heat-shrink tubing, insulating sheet material, or insulating coating applied in liquid form. Methods such as these can insulate adjacent rechargeable battery cells and make separator use unnecessary. In particular, a configuration that adopts a method of cooling the battery stack via a cooling plate, which is cooled by a technique such as employing cooling fluid, and does not rely on a ventilation system, which forcibly passes air or cooling gas between the rechargeable battery cells, does not always require separators between battery cells. Further, in a configuration that adopts a system that cools the battery stack with a coolant chilled cooling plate, there is no need to establish passageways in the insulating separators for the flow of cooling gas between the battery cells (such as in a ventilation system that cools by forcibly passing cooling gas between the rechargeable battery cells). Therefore, the overall length of the battery stack can be reduced, which is advantageous in the effort to achieve compactness.

### (Endplates 3)

As shown in FIG. 5, a pair of endplates 3 is disposed at the ends of the battery stack 5, which has rechargeable battery cells 1 and separators 2 stacked alternately and moisture protection sheets 38 covering the sides. The battery stack 5 is bound together in a manner sandwiching the battery stack 5 between endplates 3 at both ends. Each endplate 3 has bent regions 3b that bend inward towards the battery stack at right angles on both sides, and those bent regions 3b overlap over the side-walls 2b of each end separator 2B. The endplates 3 are made of material with sufficient strength such as metal. In addition, the endplates 3 are provided with attachment structures for mounting on the lower case 71 shown in FIG. 1 as well as structures for attachment of other parts such as the circuit board holder bottom-cover 25 disposed on the upper surface.

### (Battery Stack Linking Pieces 7)

Each endplate 3 has screw-holes opened through each of the four corners for connecting the binding pieces 4. Further, as shown in the exploded oblique view of FIG. 5, battery stack linking pieces 7 for linking battery stacks 5 together can also be attached using the same screw-holes. The battery stack linking pieces 7 are metal pieces essentially the same height as the endplates 3. Each battery stack linking piece 7 is provided with angled pieces 7b that are bent to project outward from the surface of the endplate 3 in a direction opposite the binding pieces 4. In the example of FIG. 5, angled pieces 7b are established vertically in sets of three, and by opening through-holes through some of the angled pieces 7b, battery stacks 5 disposed adjacently in the battery cell stacking direction can be linked together using the through-holes. Naturally, besides screw fastening via the through-holes, it should go without saying that other fastening schemes can be applied appropriately.

### (Binding Pieces 4)

As shown in FIGS. 2-5, binding pieces 4 are disposed on both sides of a battery stack 5, which has endplates 3 covering both ends, and are connected to the pair of endplates 3 to bind the battery stack 5 together. As shown in the exploded oblique view of FIG. 5, each binding piece 4 is provided with a main section 41 that covers the side of the battery stack 5, bent pieces 42 that attach to the endplates 3 bent from both ends of the main section 41, a plurality of upper retaining projections 43 established on the upper edge of the main section 41, a bottom projecting section 45 bent from the bottom edge of the main section 41 to hold part of the bottom surface of the battery stack 5, and binding connectors 44 that project from the bottom part of the binding piece 4. This type of binding piece 4 is configured from material with sufficient strength such as metal hardware.

### (Upper Retaining Projections 43)

The upper edge of each binding piece 4 is provided with a plurality of upper retaining projections 43 disposed at regular intervals to press against the top of the battery stack 5. In the example in the exploded oblique view of FIG. 5, slits are cut next to the upper edge of the main section 41 in a broken line arrangement, and the rectangular pieces between the slits and the upper edge (of the binding piece 4) are bent to protrude inward (towards the battery stack 5). Upper retaining projections 43 with this structure can be formed as a unit by working (cutting, stamping, etc.) the sheet-metal binding piece 4. By making the upper retaining projections 43 protrude towards the side of the battery stack 5, the bottom edge of each protruding rectangular piece, which is the upper edge of each slit, mates with the ledge shaped indent 32 formed in the side-wall 2b of each separator 2. With upper retaining projection 43 pressure applied to the horizontal ledge surface 33 of each indent 32, the binding piece 4 presses on the upper surface of the battery stack 5 through the upper surface plates 2c of the separators 2. In this manner, the upper retaining projections 43 of the binding pieces 4 indirectly press on the top of the battery stack 5 through the separators 2. In particular, this has the positive feature that by establishing an upper retaining projection 43 for each separator 2, each separator 2 is reliably pressed through its indent 32. Further, by pressing on the upper surface of the battery stack 5 at each separator 2, which applies pressure in a distributed manner, the upper surface of the battery stack 5 can attain an approximately constant height.

As described above, indents 32 that mate with the upper retaining projections 43 are formed as a series of concave regions that correspond to the series of upper retaining projections 43 protruding from the inside surface of each binding piece 4. This makes it easy to align each upper retaining projection 43 with each indent 32 when binding pieces 4 are attached to the sides of the battery stack 5, and simplifies the assembly operation of inserting a plurality of upper retaining projections 43 in the indents 32 of a plurality of separators 2.

Further, latching hooks 31 described subsequently are formed on the backsides of the recessed back wall sections 34 of the indents 32, namely the latching hooks 31 project inward from the sides of the battery stack 5. When the binding pieces 4 are attached, pressure is applied to push the latching hooks 31 on the backsides of the recessed back wall sections 34 further inward. This has merit in that connection is strengthened between the latching hooks 31 and latching hook mating pieces 35 on the circuit board holder bottom-cover 25.

### (Moisture Protection Sheets 38)

As shown in FIG. 5, moisture protection sheets 38 are attached to the sides of the battery stack 5. Since the rechargeable battery cells 1 are stacked with intervening separators 2, separator 2 side-walls 2b are exposed on the sides of the battery stack 5. Accordingly, gaps between adjacent separator 2 side-walls 2b are closed-off by the moisture protection sheets 38. A moisture protection sheet 38 is made of water resistant insulating material, and preferably that material is flexible and stretchable. For example, the moisture protection sheets 38 can be made of resin such as rubber sheet. This allows flexible distortion of the moisture protection sheets 38 to absorb any dimension changes resulting from expansion of a rechargeable battery cell 1 in the battery stack 5, and thereby sustain moisture protection. For example, flexible materials such as EDPM (ethylene propylene diene monomer) and PVC (polyvinyl chloride) can be used with acrylic based double-sided tape attached.

Moisture protection sheets 38 are only attached to the sides of the battery stack 5. As described previously, the ends of the battery stack 5 are covered by endplates 3. At the battery stack 5 ends, the surfaces of moisture protection sheets 38 attached to the side-walls 2b of the end separators 2B are sandwiched under the bent regions 3b of the endplates 3 and held in place by the binding pieces 4. The moisture protection sheets 38 can distort resiliently, moisture ingress from the sides of the endplates 3 can be avoided, and this can achieve a water-tight configuration at the ends of the battery stack 5.

It is desirable to provide an adhesive layer on the moisture protection sheets 38 that attach to the battery stack 5 surfaces. For example, by making the moisture protection sheets 38 in the form of adhesive sheets, moisture protection sheet 38 attachment operations can be simplified.

Further, as shown in FIG. 5, bottom edges of the moisture protection sheets 38 are folded inward with an L-shaped cross-section. These folded regions cover the corners between side and bottom surfaces of the battery stack 5. Thermally conducting sheet (described in detail later) disposed on the bottom surface of the battery stack 5 is overlapped with the folded regions 38b of the moisture protection sheets 38. This arrangement completely covers the bottom surfaces of the rechargeable battery cells 1, which make up the battery stack 5, with moisture protection sheet 38 and thermally conducting sheet. The battery stack 5 is attached on the cooling plate 61 (described in detail later) in a configuration that maintains moisture protection.

### (Circuit Board Holder Bottom-Cover 25)

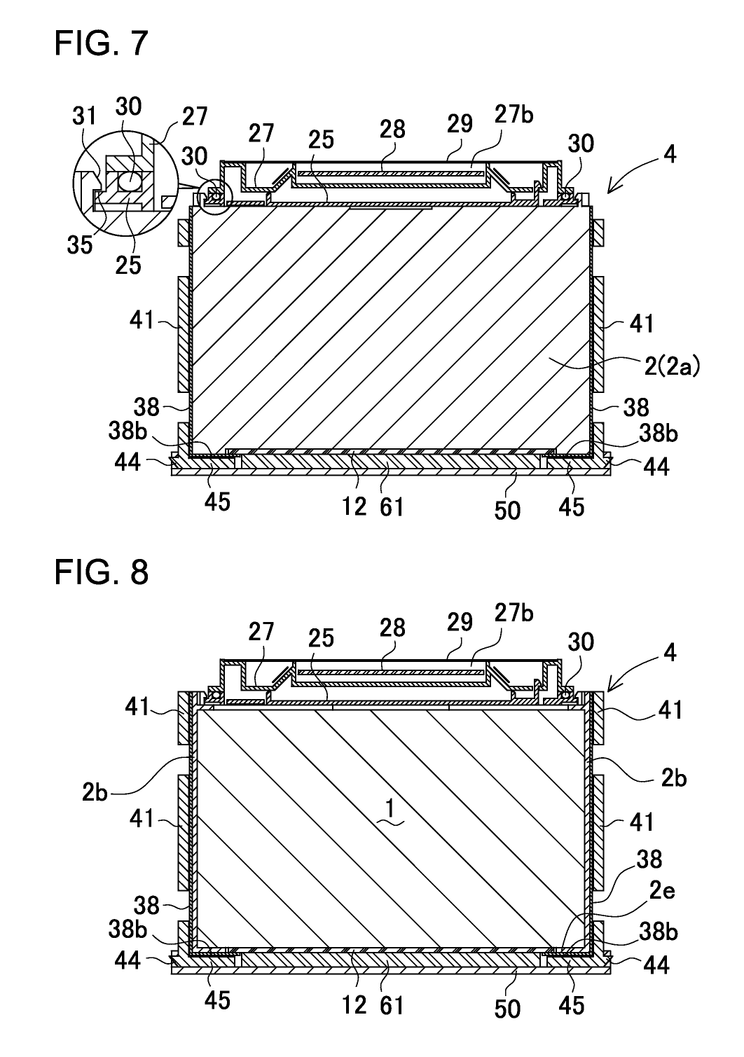

As shown in the exploded oblique view of FIG. 5, the upper surface of the battery stack 5 is closed-off by the circuit board holder bottom-cover 25. The circuit board holder 27 is attached on the upper surface of the circuit board holder bottom-cover 25. The circuit board holder 27 retains the circuit board 28 and is closed-off on top by the shield plate 29. FIG. 7 is a vertical cross-section through the line VII-VII in FIG. 2 to illustrate the attachment structure of the circuit board holder bottom-cover 25 on the battery stack 5.

### (Latching Hooks 31)

The circuit board holder bottom-cover 25 interlocks with the separators 2 via a latching mechanism. In the example shown in the cross-section view of FIG. 7, the latching mechanism includes latching hooks 31 established on the separators 2. Each latching hook 31 is established on the inside surface of each recessed back wall section 34 in the separator 2 side-wall 2b, and has a hook-shaped end that projects inward towards the center of the separator 2. In this example, the latching mechanism is located outward from the battery cell electrode terminals 1b.

### (Latching Hook Mating Pieces 35)

The latching hooks 31 mate with latching hook mating pieces 35 established on the circuit board holder bottom-cover 25. The latching hook mating pieces 35 are formed on the sides of the circuit board holder bottom-cover 25. As described previously, the top of the battery stack 5 has separator 2 side-walls 2b formed in a manner projecting slightly above the upper surface on both sides, and the circuit board holder bottom-cover 25 is inserted and attached between those projecting sections of the side-walls 2b. Here, since the side-walls 2b are formed with recessed ledge shaped indents 32, the sides of the circuit board holder bottom-cover 25 are also formed with a corresponding pattern of recessed regions. These patterns of recessed regions are useful for aligning the circuit board holder bottom-cover 25 on the top of the battery stack 5. Further, the latching hook mating pieces 35 are established inside the recessed regions, which are positioned where the backsides of the side-wall 2b indents 32 insert into the sides of the circuit board holder bottom-cover 25.

The circuit board holder bottom-cover 25 is provided with openings to allow connection to the rechargeable battery cell 1 electrode terminals 1b. As shown in the exploded oblique view of FIG. 5, a plurality of bus-bars 6 are preferably insertion molded into the circuit board holder bottom-cover 25 to make electrode terminal 1b connections. This allows bus-bar 6 connection of the electrode terminals 1b to be accomplished at the same time the circuit board holder bottom-cover 25 is attached on top of the battery stack 5 and is useful for improving assembly operation efficiency.

The circuit board holder bottom-cover 25 is also provided with openings corresponding to the location of each battery cell safety valve 1c. These openings connect with a gas duct 26 built into the circuit board holder 27 attached on top of the circuit board holder bottom-cover 25.

The circuit board holder bottom-cover 25 is preferably attached to the upper surface of the battery stack 5 in a water-tight manner. Accordingly, As shown in the cross-section of FIG. 7, the circuit board holder bottom-cover 25 is designed to have no gaps when the latching hooks 31 on the separators 2 are locked into the latching hook mating pieces 35 on the circuit board holder bottom-cover 25. Depending on requirements, resilient material such as gasket material can be disposed in connecting regions between the circuit board holder bottom-cover and the battery stack.

Further, as shown in the exploded oblique view of FIG. 5, the upper edges of the moisture protection sheets 38 are provided with a plurality of cut-outs 38c. These cut-outs 38c are established at positions corresponding to the location of the separator 2 latching hooks 31. The cut-outs 38c are established to allow connection of binding piece 4 upper retaining projections 43 in separator 2 indents 32 without sandwiching the moisture protection sheet 38 in between, and to allow interference-free mating of the latching hooks 31 with the latching hook mating pieces 35. Provision of cut-outs 38c avoids unnecessary distortion of the moisture protection sheets 38 and improves their sealing action.

### (Circuit Board Holder 27)

### (Resilient Material 30)

The circuit board holder 27 is attached on top of the circuit board holder bottom-cover 25. Resilient material 30 is disposed between the circuit board holder bottom-cover 25 and the circuit board holder 27. As shown in the enlarged inset in the cross-section view of FIG. 7, insertion of resilient material 30 at the interface between the top of the battery stack 5 and the circuit board holder 27 reliably implements a moisture protecting structure. Flexible components such as O-rings or gasket material can be used as the resilient material 30.

Instead of targeting a moisture protecting structure attained by direct attachment of the circuit board holder 27 on top of the battery stack 5, a configuration is adopted that first covers the top of the battery stack 5 with the circuit board holder bottom-cover 25 and then connects the circuit board holder 27 to the circuit board holder bottom-cover 25. This allows the circuit board holder bottom-cover 25 to manage moisture protection with respect to electrode terminals 1b and safety valves 1c on the upper surface of the battery stack 5 while allowing the circuit board holder 27 to handle circuit board 28 retention and gas duct 26 connection. By distributing a plurality of functions in this manner to achieve moisture protection, operations to implement a moisture protecting structure can be simplified.

### (Gas Duct 26)

By incorporating a gas duct 26, the circuit board holder 27 serves additionally to safely exhaust gas discharged from a rechargeable battery cell 1 safety valve 1c to the outside. Specifically, a gas duct 26 is provided inside the circuit board holder 27, the gas duct 26 is connected with the safety valve 1c on each rechargeable battery cell 1, and additional ducting connects the gas duct 26 to the outside. If the internal pressure of a rechargeable battery cell 1 rises abnormally, this allows discharged gas to be safely exhausted to the outside. Note that the gas duct is not limited to a structure that is a single-piece with the circuit board holder 27, and it should go without saying that the circuit board holder and the gas duct can also be made as separate pieces.

The circuit board holder 27 establishes circuit board storage space 27b to hold the circuit board 28. The circuit board 28 held in the circuit board storage space 27b is enclosed above by the shield plate 29 described below.

### (Circuit Board 28)

A circuit board 28 is provided that carries electronic circuitry electrically connected to the rechargeable battery cells 1. Low-voltage circuitry is mounted on the circuit board 28 to implement protection circuits for the battery cells that make up the battery stack 5.

By covering the circuit board 28 with thermally conducting resin, a completely moisture protecting configuration can be achieved. For example, potting compound can be used appropriately for this type of resin. By encapsulating the circuit board 28 in potting compound, heat transfer from the electronic components can be improved, which is also advantageous from a heat dissipation viewpoint. In addition, by thermally coupling the encapsulating resin with the shield plate 29, heat transfer can be still further improved for even greater heat dissipation.

### (Shield Plate 29)

The shield plate 29 is disposed on the upper surface of the circuit board holder 27 and closes-off the circuit board storage space 27b. Preferably, the shield plate 29 is a metal plate with superior electrical conductivity such as an aluminum plate. This arrangement blocks externally generated random noise with the shield plate 29, electrically (and electromagnetically) shields the circuit board 28, and insures stable circuit operation.

It is desirable to seal the circuit board storage space 27b closed with the shield plate 29. This utilizes the shield plate 29 for the additional purpose of enclosing the circuit board 28 and allows the shield plate 28 to simultaneously provide physical (mechanical) protection to the circuit board 28. This can achieve structural simplification and parts cost reduction.

In particular, since metal plates are disposed on other surfaces of the battery stack 5 limiting shield plate 29 disposition to the upper surface only, cost associated with additional noise-reduction parts can be decreased. Specifically, since the battery stack 5 has its bottom surface covered by metal plate including the cooling plate 61, its end surfaces covered by endplates 3, and its side surfaces covered by binding pieces 4, there is no need for additional shield plating on those surfaces.

In the example of FIG. 7, although a water-tight structure is obtained with a configuration that divides the upper region into a circuit board holder 27 and a circuit board holder bottom-cover 25, that region can also be made in a single-piece structure. In that case, a water-tight battery stack 5 upper surface can be achieved by attaching the bottom surface of the integrated circuit board holder bottom-cover 25 to the top of the battery stack 5 via moisture sealing material such as gaskets.

### (Battery Stack 5 Bottom Surface)

The bottom surface of the battery stack 5 is attached to the cooling plate 61 via thermally conducting sheet. Cross-section views of the battery stack 5 connected with the cooling plate 61 are shown in FIGS. 7 and 8. The upper surface of the battery stack 5 is pressed upon by the circuit board holder bottom-cover 25, and bottom surface is connected in intimate contact with the cooling plate 61. By sandwiching the battery stack 5 from above and below in this manner, upper surfaces of the battery cells that make up the battery stack 5 can be aligned in a single plane. From a different perspective, by making the bottom surface of the battery stack 5 planar, the cooling plate 61 connecting surface is in a single plane, and thermal coupling can be achieved more stably and reliably.

As shown in the cross-sections of FIGS. 7 and 8, binding piece 4 bottom projecting sections 45 are located on the bottom surface of the battery stack 5 jutting out from the corners at the edges of the sides of the battery stack 5. The bottom of the battery stack 5 is open in the region between the pair of bottom projecting sections 45, and the cooling plate 61 is disposed in that open region. The open region is made with a size that can be closed-off with the cooling plate 61.

### (Thermally Conducting Sheet 12)

Also as shown in the cross-sections of FIGS. 7 and 8, material that transfers heat such as thermally conducting sheet 12 is disposed between the battery stack 5 and the cooling plate 61. Preferably, thermally conducting sheet 12 material has superior electrically insulating and thermally conducting properties, and some degree of flexibility is also desirable. Materials with these properties include resins such as acrylic-based, urethane-based, epoxy-based, and silicone-based resins. With these types of intervening materials, the battery stack 5 is electrically insulated from the cooling plate 61. In particular, when the external case of the rectangular battery cells is made of metal and the cooling plate 61 is a metal plate, insulation is required to avoid conduction through the bottom surfaces of the battery cells. If the battery cell external cases have an insulating covering such as heat-shrink tubing, safety and reliability is improved when an electrically insulating thermally conducting sheet 12 is inserted for additional electrical insulation. Pastes such as heat transfer compound can also be used in place of thermally conducting sheet, and an additional insulating film can intervene to insure electrical insulation. Further, cooling pipes can be formed from electrically insulating material. When sufficient electrical insulation is designed into the system, it is possible to eliminate the thermally conducting sheet.

By making the thermally conducting sheet 12 flexible, thermally conducting sheet 12 surfaces can distort resiliently and fill any gaps between the battery stack 5 and cooling plate 61 contacting surfaces to improve thermal coupling.

As shown in the cross-section of FIG. 8, component materials on the bottom surface of the battery stack 5 have the following positional relation. Thermally conducting sheet 12 is disposed on the bottom surfaces of the rechargeable battery cells 1 between separator 2 bottom projections 2e, and the folded regions 38b of the moisture protection sheets 38 attached to the separators 2 are positioned to cover the interface between the separator 2 bottom projections 2e and the thermally conducting sheet 12. This can realize a water-tight structure without the cooling plate 61 attached. At assembly time, after attaching moisture protection sheets 28 to the stack of rechargeable battery cells 1 and separators 2, which have thermally conducting sheet 12 disposed on the bottom surface, the battery stack 5 is bound together with binding pieces 4. Here, it is desirable for the bottom projecting sections 45 of the binding pieces 4 to extend over, and cover the interface between the separator 2 bottom projections 2e and the thermally conducting sheet 12. With this arrangement, the weight of the battery stack 5 applies pressure to the moisture protection sheet 38 folded regions 38b and the thermally conducting sheet 12 between the binding piece 4 bottom projecting sections 45 and the battery stack 5 to improve hermetic sealing.

### (Attachment Structure)

An attachment structure is provided to mount the battery stack 5 on top of the cooling plate 61. In the example shown in FIGS. 2-5, the attachment structure is made up of binding connectors 44 that project from the bottom edges of the binding piece 4 main sections 41, and plate connectors disposed on the bottom along the cooling plate 61. A plurality of binding connectors 44 are established with separation between each binding connector 44. In the example of FIG. 2, binding connectors 44 are established at three locations (at the center and both ends) along the bottom of each main section 41.

### (Latching Pieces)

In the example of FIGS. 3 and 4, the ends of the binding connectors 44 are formed as latching pieces with hook shapes. Projection of the hook shaped latching pieces is in a direction outward from the battery stack 5.

### (Plate Connectors)

Plate connectors are disposed along the cooling plate 61 as connecting components to link with the binding connectors 44. The plate connectors are provided at positions corresponding to binding connector 44 locations. In the example of FIGS. 2-4, connecting bars 50 formed with latching holes 51 that can lock together with the latching pieces are used as the plate connectors. Hook shaped latching pieces (binding connectors 44) insert in, and latch into the latching holes 51, and this allows the binding pieces 4 to be easily attached to the cooling plate 61.

### (Connecting Bars 50)

As shown in the oblique views of FIGS. 2-4, each connecting bar 50 is shaped as a rectangular strip that is bent into a U-shape (viewed from the side). Each rectangular strip is made from sheet-metal of sufficient strength. The rectangular strip can be made more robust by forming a stepped ridge on its surface. Each connecting bar 50 is made long enough to accommodate the cooling plate 61 between its bent ends. Latching holes 51 that implement connection of the plate connectors are opened through the bent ends of each connecting bar 50. By using connecting bars 50 in this manner, cooling plate 61 attachment can be easily augmented with additional plate connectors. In particular, when the cooling plate 61 is endowed with a capability such as coolant circulation, connecting components can be added without making the shape of the cooling plate 61 more complex.

### (Coolant Circulation Plumbing)

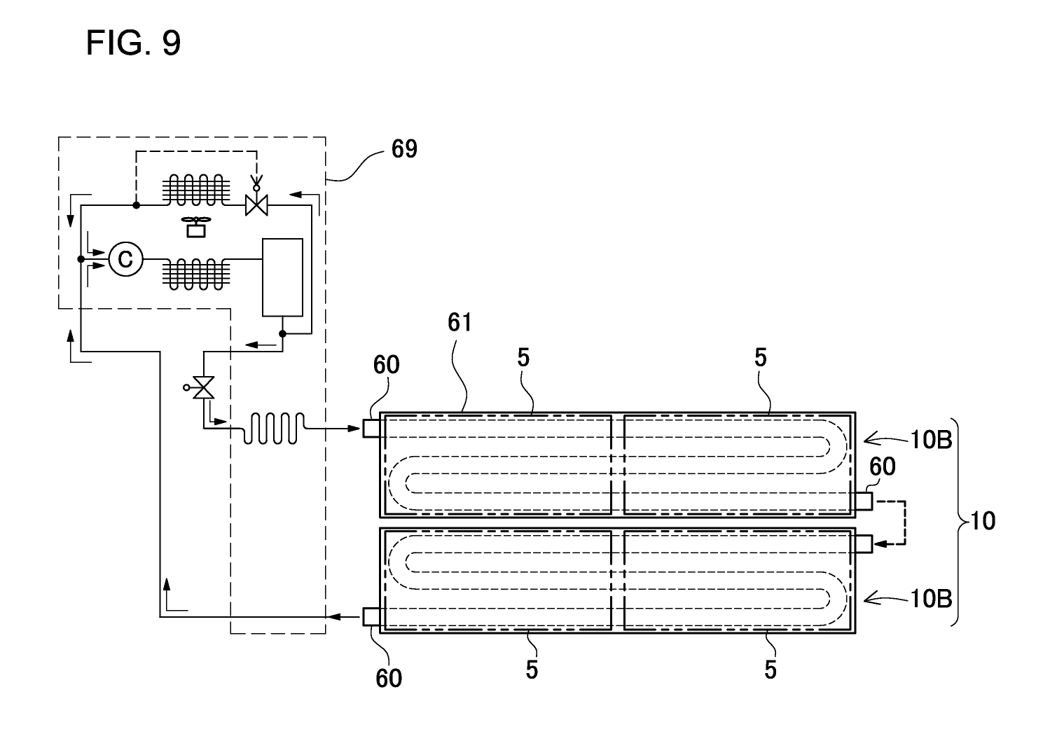

The cooling plate 61 has coolant circulation plumbing disposed inside. FIG. 9 shows one example of this type of coolant circulation plumbing. The battery assembly 10 shown in FIG. 9 has a plurality of battery stacks 5 with a plurality of stacked rechargeable batteries 1 disposed on top of cooling plates 61. The cooling plates 61 are disposed in a thermally coupled manner with the rechargeable battery cells 1 that make up the battery stacks 5. The cooling plate 61 has coolant passageways that connect with a cooling mechanism 69. The battery assembly 10 has its component battery stacks 5 in contact with the cooling plates 61 allowing direct effective cooling. In addition, not only can the battery stacks be cooled, but various components disposed, for example, at the ends of the battery stacks, can also be cooled at the same time. By putting cooling plates 61, which have internal cooling pipes 60 that circulate coolant, in contact with the bottom surfaces of the battery stacks 5, heat dissipation characteristics are improved and the power source apparatus becomes capable of stable operation even at high power output.

### (Cooling Plate 61)

Each cooling plate 61 is a heat dissipating body designed to conduct heat from the rechargeable battery cells 1 to the outside, and in the example of FIG. 9, each cooling plate 61 is plumbed with coolant passageways. As a heat exchanger, the cooling plate 61 houses copper or aluminum coolant passageways that circulate coolant, which is a liquefied cooling fluid. The coolant passageways are cooling pipes 60, which are thermally coupled with the upper panel of the cooling plate 61. Thermal insulating material is disposed between the cooling pipes 60 and the bottom panel of the cooling plate 61 to thermally insulate the cooling pipes 60 from the bottom panel. Instead of incorporating this type of coolant-based system in the cooling plate 61, the cooling plate can also be configured simply as a metal plate. For example, the cooling plate can have the form of a metal heat sink with heat radiating fins and superior heat transfer and heat radiating properties. Further, the heat sink is not limited to metal materials, and electrically insulating, thermally conducting heat transfer sheet can also be used.

Coolant in liquid form is supplied from the cooling mechanism 69 to the coolant passageways plumbed inside the cooling plate 61. The cooling process can be more efficient when the coolant is supplied from the cooling mechanism 69 in liquid form and the cooling plate 61 is cooled via the heat of vaporization due to coolant transition from liquid to gas inside the coolant passageways.

In the example of FIG. 9, two battery stacks 5 are mounted on top of a single cooling plate 61. As described previously, two battery stacks 5 are linked together in the lengthwise direction, which is the rectangular battery cell stacking direction, to form one linked battery stack unit 10B. Two battery stacks 5 linked together in this manner are supported by a single cooling plate 61. Two linked battery stack units 10B are arranged in parallel disposition to form the battery assembly 10.

Also in the example of FIG. 9, each cooling plate 61 extends lengthwise in the rectangular battery cell stacking direction and the cooling pipes 60 are plumbed in a serpentine pattern to dispose three rows of straight cooling pipe 60 segments under the bottom surfaces of the battery stacks 5. Further, by connecting the cooling pipes 60 of each linked battery stack unit 10B together, a common path is established for coolant circulation. When a plurality of battery stacks 5 are mounted on a single cooling plate 61 and cooled in this manner, the cooling mechanism can be shared and the cooling plates 61 can be standardized to achieve a lower cost simplified cooling system. However, a plurality of separate cooling pipes can also be disposed under the bottom of the battery stacks. For example, the folded-back regions of the serpentine cooling pipes can be eliminated to establish a plurality of individual cooling pipes. Since this eliminates the folded-back regions of the cooling pipes, it can contribute to overall weight reduction. With this configuration, separate cooling pipes can be connected to establish a common coolant path. Note that the cooling pipe configuration can be changed to optimally suit the application.

A cooling plate 61 can also function as a means of thermal equalization to equalize the temperature of the rechargeable battery cells 1. Specifically, the cooling plate 61 can control the amount of thermal energy absorbed from the various rechargeable battery cells 1 to reduce temperature differences between cells. For example, battery cells in the center of the battery stack, which tend to become hot, can be cooled efficiently while battery cells at the ends of the stack, which are located in cooler regions, can be cooled less. This can reduce the temperature variation between rechargeable battery cells and avoid over-charging or over-discharging of degraded battery cells in a particular region.

Although FIG. 9 shows an example of cooling plates 61 disposed on the bottom surfaces of the battery stacks 5, the present invention is not limited to that configuration. For example, cooling plates can be disposed on both sides of the rechargeable battery cells or on one side surface. Further, cooling pipes with coolant flowing inside can be disposed in direct contact with the bottom surfaces of the battery stacks without intervention of a metal plate such as the cooling plate.

As described previously, the power source apparatus 100 for the first embodiment has battery stacks 5 configured as water-tight structures that protect the rechargeable battery cells 1 from moisture such as condensation.

For a configuration that aims at power source apparatus size reduction by disposing the circuit board on top of the battery stack, how to provide moisture protection for the previously described electrode terminals 1b, how to separate the gas duct 26 and the circuit board 28, and how to provide moisture protection for the circuit board 28 are design challenges. Specifically, since gas discharged via the gas duct 26 has detrimental effects on the circuit board 28, it is necessary to separate the space allotted for holding the gas duct 26 and the circuit board 28. However, separation of the gas duct 26 and the circuit board 28, water-tight construction of the electrode terminals 1b, and simultaneous achievement of power source apparatus 100 size reduction is not a trivial task. In answer to these considerations, the power source apparatus 100 described above for the first embodiment is configured to fasten the circuit board holder bottom-cover 25 on top of the battery stack 5 via latching hooks 31 positioned outward from the electrode terminals 1b, and to attach the circuit board holder 27 on top of the circuit board holder bottom-cover 25 in a water-tight manner via resilient material 30. By attaching the circuit board holder 27 on top of the circuit board holder bottom-cover 25, the space between the circuit board holder bottom-cover 25 and the circuit board holder 27 can be divided into regions where the electrode terminals 1b are located and a region where the gas duct 26 is established. Circuit board storage space 27b is formed above the upper surface of the circuit board holder 27 and the circuit board 28 can be disposed in that space in a manner isolated from the gas duct 26. Wiring to connect the circuit board 28 with the electrode terminals 1b is run through holes (not illustrated) established in the circuit board holder 27. Further, since the circuit board 28 held in the circuit board storage space 27b is covered with resin, it can be maintained in a completely water-tight configuration.

Accordingly, with the simple structure described above, which covers the upper surface of the battery stack with the circuit board holder bottom-cover 25 and circuit board holder 27, water-tight electrode terminals 1b, separation between the gas duct 26 and the circuit board 28, and a water-tight circuit board 28 can be achieved. Consequently, this also has the characteristic that power source apparatus enlargement is avoided.

The power source apparatus described above can be used as a power source on-board a vehicle. An electric powered vehicle such as a hybrid vehicle driven by both an engine and an electric motor, a plug-in hybrid vehicle, or an electric vehicle driven by an electric motor only can be equipped with the power source apparatus and use it as an on-board power source.

### (Power Source Apparatus in a Hybrid Vehicle Application)

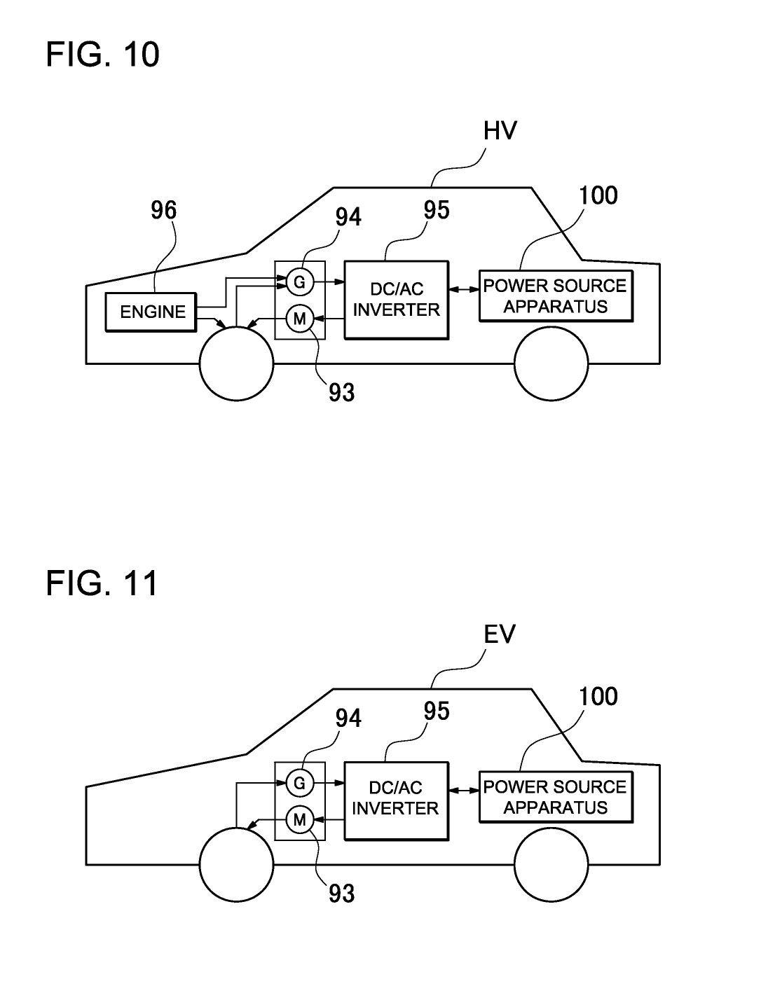

FIG. 10 shows an example of power source apparatus installation on-board a hybrid vehicle, which is driven by both an engine and an electric motor. The vehicle HV equipped with the power source apparatus 100 shown in this figure is provided with an engine 96 and a driving motor 93 to drive the vehicle HV, a power source apparatus 100 to supply power to the motor 93, and a generator 94 to charge the power source apparatus 100 batteries. The power source apparatus 100 is connected to the motor 93 and generator 94 via a direct current-to-alternating current (DC/AC) inverter 95. The vehicle HV runs on both the motor 93 and engine 96 while charging the batteries in the power source apparatus 100. In operating modes where engine efficiency is poor such as during acceleration and low speed cruise, the vehicle is driven by the motor 93. The motor 93 operates on power supplied from the power source apparatus 100. The generator 94 is driven by the engine 96 or by regenerative braking when the vehicle brake pedal is pressed and operates to charge the power source apparatus 100 batteries.

### (Power Source Apparatus in an Electric Vehicle Application)

FIG. 11 shows an example of power source apparatus installation on-board an electric vehicle, which is driven by an electric motor only. The vehicle EV equipped with the power source apparatus 100 shown in this figure is provided with a driving motor 93 to drive the vehicle EV, a power source apparatus 100 to supply power to the motor 93, and a generator 94 to charge the power source apparatus 100 batteries. The power source apparatus 100 is connected to the motor 93 and generator 94 via a DC/AC inverter 95. The motor 93 operates on power supplied from the power source apparatus 100. The generator 94 is driven by energy from regenerative braking and operates to charge the power source apparatus 100 batteries.

### (Power Source Apparatus in a Power Storage Application)

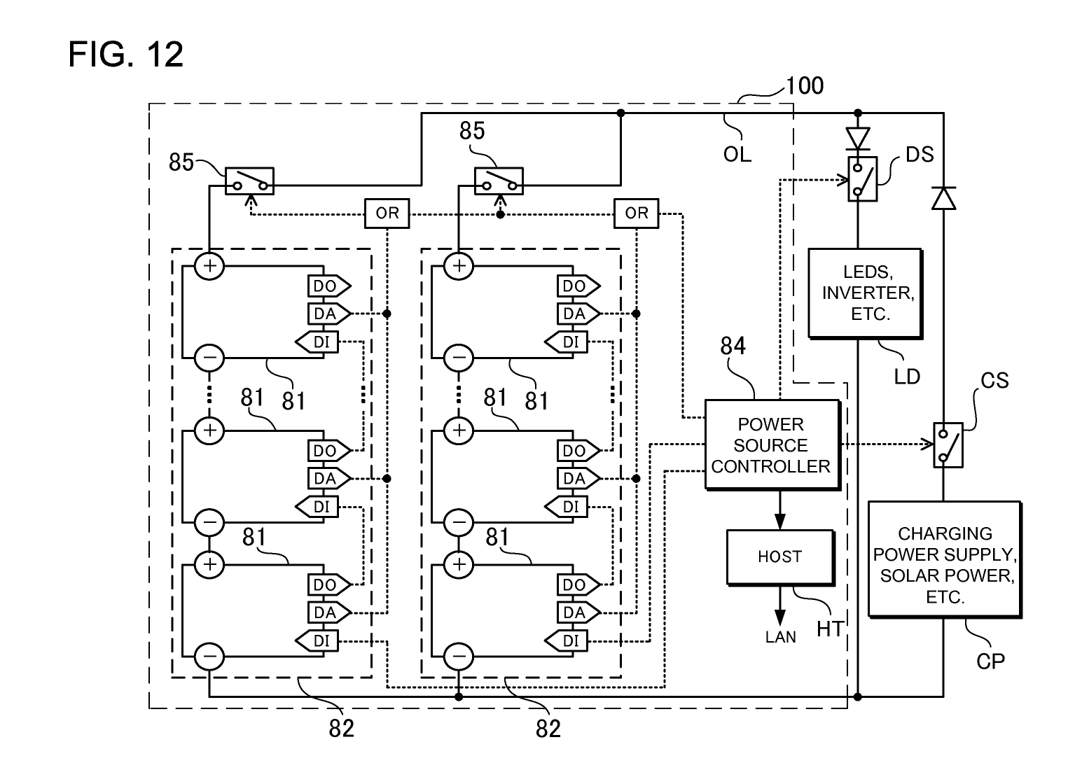

The power source apparatus can be used not only as the power source in motor vehicle applications, but also as an on-board (mobile) power storage resource. For example, it can be used as a power source system in the home or manufacturing facility that is charged by solar power or late-night (reduced-rate) power and discharged as required. It can also be used for applications such as a streetlight power source that is charged during the day by solar power and discharged at night, or as a backup power source to operate traffic signals during power outage. An example of a power source apparatus for these types of applications is shown in FIG. 12. The power source apparatus 100 shown in this figure has a plurality of battery packs 81 connected to form battery units 82. Each battery pack 81 has a plurality of battery cells connected in series and/or parallel. Each battery pack 81 is controlled by a power source controller 84. After charging the battery units 82 with a charging power supply CP, the power source apparatus 100 drives a load LD. Accordingly, the power source apparatus 100 has a charging mode and a discharging mode. The load LD and the charging power supply CP are connected to the power source apparatus 100 through a discharge switch DS and a charging switch CS respectively. The discharge switch DS and the charging switch CS are controlled ON and OFF by the power source apparatus 100 power source controller 84. In the charging mode, the power source controller 84 switches the charging switch CS ON and the discharge switch DS OFF to allow the power source apparatus 100 to be charged from the charging power supply CP. When charging is completed by fully-charging the batteries or by charging to a battery capacity at or above a given capacity, the power source apparatus can be switched to the discharging mode depending on demand by the load LD. In the discharging mode, the power source controller 84 switches the charging switch CS OFF and the discharge switch DS ON to allow discharge from the power source apparatus 100 to the load LD. Further, depending on requirements, both the charging switch CS and the discharge switch DS can be turned ON to allow power to be simultaneously supplied to the load LD while charging the power source apparatus 100.

The load LD driven by the power source apparatus 100 is connected through the discharge switch DS. In the discharging mode, the power source controller 84 switches the discharge switch DS ON to connect and drive the load LD with power from the power source apparatus 100. A switching device such as a field effect transistor (FET) can be used as the discharge switch DS. The discharge switch DS is controlled ON and OFF by the power source apparatus 100 power source controller 84. In addition, the power source controller 84 is provided with a communication interface to communicate with externally connected equipment. In the example of FIG. 12, the power source controller 84 is connected to an external host computer HT and communicates via known protocols such as universal asynchronous receiver transmitter (UART) and recommended standard-232 (RS-232C) protocols. Further, depending on requirements, a user interface can also be provided to allow direct user operation.

Each battery pack 81 is provided with signal terminals and power terminals. The signal terminals include a battery pack input-output terminal DI, a battery pack error output terminal DA, and a battery pack connecting terminal DO. The battery pack input-output terminal DI allows output and input of signals to and from the power source controller 84 and other battery packs. The battery pack connecting terminal DO allows output and input of signals to and from another related battery pack. The battery pack error output terminal DA serves to output battery pack abnormalities to components and devices outside the battery pack. In addition, the power terminals allow the battery packs 81 to be connected in series or parallel. The battery units 82 are connected in parallel to the output line OL via parallel connecting switches 85.

The power source apparatus and vehicle and power storage device equipped with that power source apparatus of the present invention can be appropriately used as a power source apparatus in a vehicle such as a plug-in hybrid electric vehicle that can switch between an electric vehicle mode and a hybrid vehicle mode, a hybrid (electric) vehicle, and an electric vehicle. The present invention can also be appropriately used in applications such as a server computer backup power source that can be rack-installed, a backup power source apparatus for a wireless base station such as a mobile phone base station, a power storage apparatus for the home or manufacturing facility, a streetlight power source, a power storage apparatus for use with solar cells, and a backup power source in systems such as traffic signals.

1-10. (canceled)

11. A power source apparatus comprising:
a battery stack having a plurality of rectangular shaped rechargeable battery cells stacked together;
a circuit board carrying electronic circuitry electrically connected with the rechargeable battery cells;
a circuit board holder disposed on the upper surface of the battery stack that establishes storage space to hold the circuit board; and
a conducting shield plate installed on top of the circuit board holder that closes-off at least the upper surface of the circuit board storage space holding the circuit board inside.

12. The power source apparatus as cited in claim 11, further comprising:
a pair of metal endplates with an endplate disposed at each end of the battery stack; and
metal binding pieces that cover the sides of the battery stack and bind the battery cells in the stack by fastening the pair of endplates together.

13. The power source apparatus as cited in claim 11, wherein the shield plate covers only the upper surface of the battery stack.

14. The power source apparatus as cited in claim 11, wherein the shield plate is made of aluminum.

15. The power source apparatus as cited in claim 11, wherein the circuit board is covered with thermally conducting resin and the shield plate is thermally coupled with the resin.

16. The power source apparatus as cited in claim 11, wherein the circuit board circuitry is low voltage circuitry.

17. The power source apparatus as cited in claim 11, further comprising:
a circuit board holder bottom-cover to retain the bottom surface of the circuit board holder;
wherein the circuit board holder bottom-cover is attached to the upper surface of the battery stack in a water-tight manner.

18. The power source apparatus as cited in claim 11, further comprising:
a cooling plate that passes coolant (cooling medium) through its interior and is thermally coupled with one surface of the battery stack to transfer heat from the battery stack;
wherein thermally conducting sheet is disposed between the cooling plate and the battery stack to connect the cooling plate and battery stack in a thermally coupled manner.

19. A vehicle equipped with the power source apparatus cited in claim 11.

20. A power storage device equipped with the power source apparatus cited in claim 11.
